(19) United States
(12) Patent Application Publication
(10) Pub. No.: US 2004/0005257 A1
(43) Pub. Date: Jan. 8, 2004

(54) Crystallization system using homogenization

(76) Inventors: Chenkou Wei, Princeton Junction, NJ (US); Otute Akiti, Plainsboro, NJ (US)

Correspondence Address: STEPHEN B. DAVIS, BRISTOL-MYERS SQUIBB COMPANY, PATENT DEPARTMENT, P O BOX 4000, PRINCETON, NJ, 08543-4000, US

(21) Appl. No.: 10/419,647

(22) Filed: Apr. 21, 2003

Related U.S. Application Data
(60) Provisional application No. 60/379,351, filed on May 10, 2002.
(60) Provisional application No. 60/439,057, filed on Jan. 9, 2003.

(51) Int. Cl. B01D 9/02; B01D 9/00; C13K 1/10

(52) U.S. Cl. 422/245.1; 23/295 R

(57) ABSTRACT

A first solution and a second solution are supplied to the inlet conduit of a chamber. The chamber includes a stator formed of spaced stationery blades within which a rotor with spaced blades is rotatably received. As the rotor is rotated, high shear mixing forces are applied to the solutions and crystallization take place within the chamber. Additional mixing of the product can take place after it leaves the chamber. Seed material can be introduced to the chamber and recirculated from the inlet to the outlet as the process is performed. The process can be used to combine a solution of the material to be crystallized dissolved in a solvent and an anti-solvent solution. Alternatively, solutions containing first and second reactive intermediates in solvents can be combined under conditions of temperature and pressure that permit reaction of the first and second reactive intermediates to produce a reaction product of limited solubility in the solvent mixture.

This application claims a benefit of priority from U.S. Provisional Application No. 60/379,351, filed on May 10, 2002 and No. 60/439,057, filed on Jan. 9, 2003, the entire disclosures of which are herein incorporated by reference.

### BACKGROUND OF THE INVENTION

1. Field of the Invention

The present invention relates to a process for crystallization of organic pharmaceutical compounds and more particularly to a crystallization process that utilizes homogenization and to the apparatus for practicing such a process.

It is well known in the pharmaceutical industry that the bioavailability of a sparingly soluble organic compound is often enhanced when the compound is very pure and the molecules of the compound have a small, uniform particle size, high surface area and short dissolution time. Purification can be accomplished by crystallization of the compound from solution. However, when crystallization takes place directly in a high supersaturation environment, the resulting material is often unsatisfactory due to low purity, high friability and lack of stability because the crystal structure formation is inadequate. Further, oils commonly produced during processing of supersaturated material may solidify without sufficient structure.

It is possible to slow down the crystallization process to obtain a higher purity, more stable product. However, slowing the process decreases crystallizer productivity and produces particles which are too large, having low surface area. Such particles require high intensity milling to create a useable product.

2. Description of Related Art

To overcome those problems, and provide crystalline particles of high surface area, high chemical purity and high stability, without the need for post-crystallization milling, a crystallization process, known as the “impinging fluid jet” process, has been developed.

One well known version of the “impinging fluid jet” process is disclosed in detail in U.S. Pat. No. 5,314,506 entitled “Crystallization Method To Improve Crystal Structure And Size” issued May 24, 1994, to Midler, et al, owned by Merck & Co., Inc. of Rahway, N.J. The reader is referred to that patent for background information and the details of the process.

Basically, the impinging fluid jet process utilizes a supersaturated solution of the compound to be crystallized in solvent and an appropriate “anti-solvent” solution. Diametrically opposed high velocity jet streams of these solutions are formed by nozzles and micro mixed in a jet chamber. The mixed solutions are then transferred into a vessel where they are stirred to produce the end product. The product, such as a neutral molecule or a salt, is crystallized out by mixing the solutions which reduces the solubility of the compound in the solvent mixture.

The impinging fluid jet stream process has also been used for conducting reactive crystallization wherein a chemical reaction and controlled crystallization take place simultaneously. Patent Application Publication No.: U.S. 2002/0016,498 A1 of Feb. 7, 2002, entitled “Reactive Crystallization Method to Improve Particle Size” in the name of Am Ende et al., owned by Pfizer Inc., provides further information in this regard.

Reactive crystallization involves two reactive intermediates. Fluid streams of solutions of the reactive intermediates are impinged in a chamber under appropriate reactive conditions. For example, a first solution containing one reagent (for example, an acid) in a solvent is reacted with a second solution containing another reagent (for example, a base) in a solvent are reacted to form a product, such as a salt. The product is not soluble in the solvent mixture and thus it rapidly crystallizes out. In the pharmaceutical industry, the drug substance is often in a salt form, so reactive crystallization is commonly used.

The impinging fluid jet process produces a satisfactory result in terms of purity, particle size and stability. However, several major drawbacks of this process have been observed. For example, the nozzles used to form the fluid streams must be very accurately aligned so that the streams impinge correctly. The ratio of the flow rates of the two streams is limited by the size of the nozzles. The process cannot be used for low flow rates as the impingement would not offer a sufficient degree of mixing. Further, the apparatus used to practice the process is time consuming to set up and difficult to control.

The present invention entails a different crystallization system that can be used with both non-chemically reactive constituents and chemically reactive constituents, and which overcomes the drawbacks of the impinging fluid jet process by eliminating the need for forming fluid streams and for accurately aligning the nozzles. The ratio of the flow rates are not limited by the nozzle size and low flow rates can be accommodated. Moreover, the apparatus used to perform the process is easy to set up and control.

This system produces particles of purity, surface area and stability that are comparable to or better than obtained with the impinging fluid jet process. Like the impinging fluid jet process, the product obtained with the process of this invention does not require post-crystallization milling.

It is, therefore, a prime object of the present invention to provide a method for crystallizing an organic pharmaceutical compound using homogenization which results in particles of high purity, high stability and high surface area, without the necessity of post-crystallization milling.

It is another object of the present invention to provide a system for crystallizing an organic pharmaceutical compound using homogenization wherein the necessity for critical alignment of fluid jet streams is entirely eliminated.

It is another object of the present invention to provide a system for crystallizing an organic pharmaceutical compound using homogenization wherein the ratio of the solutions fed to the apparatus can be easily controlled.

It is another object of the present invention to provide a system for crystallizing an organic pharmaceutical compound using homogenization wherein the apparatus for performing the process can be set up relatively rapidly.

It is another object of the present invention to provide a system for crystallizing an organic pharmaceutical compound using homogenization that can be used with non-chemically reactive constituents or chemically reactive constituents.

### BRIEF SUMMARY OF THE INVENTION

The process of the present invention utilizes homogenization and takes place in a chamber consisting of an enclosed stator and a rotor assembly. The energy for crystallization is obtained from the stator and rotor assembly, instead of a collision of high velocity jet streams. The solutions are combined in the chamber by the rotation of the rotor assembly, resulting in fast crystallization. Shear forces are applied, and mixing and crystallization take place simultaneously in the chamber.

When non-chemically reactive constituents are combined, a first solution may be a supersaturated solution containing the material to be crystallized, such as a neutral molecule or a salt, dissolved in a solvent. That material-containing solution is homogenized with a second solution, which is an anti-solvent solution. Homogenizing the solutions reduces the solubility of the material in the solvent mixture, causing it to crystallize out.

As used herein, the terms “first” and “second” are not intended to denote order or to limit the invention to a particular sequence of the combination of the constituents. Further, the term “solution” is used generically and should be understood to include dispersions, emulsions, multi-phase systems and pure solvents, as well as solutions.

The process may also be used for reactive crystallization, for example, to prepare pharmaceutical salts. In that case, a first solution may contain a first reactive intermediate, such as an acid, and solvent and the second solution may contain a second reactive intermediate, such as a base, and a solvent. The solvents used for the first and second reactants may be the same or different. The reaction product is not soluble in the solvent mixture and thus rapidly crystallizes out as the solutions are mixed.

Since the process of our invention does not depend upon using nozzles to create fluid jet streams, the problem associated with the critical alignment of the opposing fluid jets is entirely eliminated. The ratio of the first and second solutions is easy to accurately control. It takes much less time to set up the apparatus to perform our process. Moreover, tests indicate that the resulting product is at least as pure, with particles that are as stable and have as high a surface area as those obtained by the impinging fluid jet process.

In accordance with one aspect of the present invention, a process is provided for crystallization of a chemical material from a first solution and a second solution. The process is performed in an apparatus including a chamber having a stator and a rotatable rotor. The process begins with the introduction of the first and the second solutions into the chamber. A high shear mixing force is applied to the solutions in the chamber to form the crystallized product by rapidly rotating the rotor relative to the stator. The crystallized product is then removed from the chamber.

The first solution may include the material to be crystallized dissolved in a solvent. The second solution may include an anti-solvent.

Alternatively, the first solution may include a solvent and a first reactive intermediate. The second solution may include a solvent and a second reactive intermediate. The mixing force is applied under conditions of temperature and pressure that permit the first and second reactive intermediates to form a product of limited solubility in the solvent mixture.

In accordance with another aspect of the present invention, non-reactive constituents are utilized in a process for the crystallization of a chemical material from a solution containing the material to be crystallized dissolved in a solvent and an anti-solvent solution. The process takes place in an apparatus with a chamber including a stator and rotor. The material-containing solution and the anti-solvent solution are introduced into the chamber. A high shear mixing force is applied to the solutions in the chamber to form the crystallized product by rapidly rotating the rotor relative to the stator. The crystallized product is removed from the chamber.

In accordance with another aspect of the present invention, reactive constituents are utilized in a process for the crystallization of a chemical material from a first solution comprising a solvent and a first reactive intermediate and a second solution comprising a solvent and a second reactive intermediate. The process takes place in apparatus including a chamber having a stator and a rotatable rotor. The first solution and the second solution are introduced into the chamber. A high shear mixing force is applied to the solutions in the chamber under conditions of temperature and pressure that permit reaction of the first and second reactive intermediates to form a product of limited solubility in the solvent mixture by rapidly rotating the rotor relative to the stator. The product is then removed from the chamber.

In both the non-reactive and reactive crystallization processes, each of the solutions may be introduced separately into the chamber where the stator and rotor are present. Altenatively, the solutions may be mixed prior to introducing the solutions into the chamber.

The step of introducing the solutions into the chamber includes the step of regulating the flow of each of the solutions into the chamber. Conventional flow regulation mechanisms such as metering pumps, valves and the like may be used for this purpose.

The temperature of one or both of the solutions may be adjusted prior to their introduction into the chamber. This may be achieved by any conventional temperature adjusting equipment, such as a heater or a cooling bath associated with the solution source.

The process may also include the step of introducing seed crystals into the chamber. The seed crystals may be placed into the chamber prior to the introduction of the solutions or seed crystals may be added to one of the solutions prior to its introduction into the chamber. These seed crystals must be insoluble in the individual solvents and in the solvent mixture.

The seed crystals are preferably introduced to the chamber on a continuous basis. This may be achieved by continuously re-circulating a portion of the contents of the chamber, such as by connecting the chamber outlet and the chamber inlet. Alternatively, a continuous supply of fresh crystals may be introduced into the chamber.

The process may include the additional step of mixing the product after it is removed from the chamber. The temperature of one or both of the solutions may be adjusted prior to introduction into the chamber.

In accordance with another aspect of the present invention, apparatus is provided for crystallization of a chemical material from a first solution and a second solution. The apparatus includes a first source of the first solution and a second source of the second solution. A chamber having a stator and a rotor is provided. Inlet means, connected to the chamber and to each of the first and second sources, receives the first and second solutions. Means are provided for rotating the rotor relative to the stator to form a crystallized product. Outlet means in the chamber permit removal of the crystallized product from the chamber.

The first solution may include the material to be crystallized dissolved in a solvent. The second solution may include an anti-solvent.

Alternatively, the first solution may include a solvent and a first reactive intermediate. The second solution may include a solvent and a second reactive intermediate. The mixing force is applied under conditions of temperature and pressure that permit reaction of the first and second reactive intermediates to form a product of limited solubility in the solvent mixture.

In accordance with another aspect of the present invention, apparatus for crystallization of a chemical material from non-reactive constituents such as a solution containing the material to be crystallized dissolved in a solvent and an anti-solvent solution is provided. The apparatus includes a first source of the material-containing solution and a second source of an anti-solvent solution. A chamber including a stator and a rotor is provided, as are means for rotating the rotor relative to the stator. Inlet means, connected to the chamber and to each of the first and second sources receives the material containing solution and the anti-solvent solution. An outlet is provided in the chamber through which the crystallized product is removed.

In accordance with another aspect of the present invention, apparatus is provided for crystallization of chemical material from reactive constituents such as a first solution comprising a solvent and a first reactive intermediate and a second solution comprising a solvent and a second reactive intermediate. The apparatus includes a first source of the first solution and a second source of the second solution. A chamber including a stator and a rotor is provided. Inlet means, connected to the chamber and to each of the first and second sources, receives the first and second solutions. Means are provided for rotating the rotor to combine the first and second solutions in the chamber under conditions of temperature and pressure that permit the first and second reactive intermediates to produce a product of limited solubility in the solvent mixture. Outlet means are also provided for removing the crystallized product from the chamber.

Whether non-reactive or reactive constituents are being combined, the inlet means of the apparatus includes first and second conduits connected to the first and the second sources, respectively. Each of the conduits has an end portion that terminates in the chamber. In this way, the solutions can be introduced separately into the chamber.

In one preferred embodiment, one of the conduits is located within the other conduit. In another preferred embodiment, the conduits include parallel end sections adjacent the chamber.

The inlet means may include a mixing conduit. The mixing conduit is located between the sources and the chamber.

The apparatus may also include first means for pumping the first solution from the first source to the chamber, through the inlet means. It may also include second means for pumping the second solution from the second source to the chamber, through the inlet means.

The rotor defines a recess. The first solution and the second solution are received within the rotor recess. The outlet means is preferably located outside the stator.

The apparatus further includes means for adjusting the temperature of the first solution. It may also include means for adjusting the temperature of the second solution.

The apparatus may further include means for recirculating a portion of the contents of the chamber. A re-circulation conduit connecting the outlet means and the inlet means may be provided for this purpose.

The apparatus further includes means for mixing the product after it is removed from the chamber.

### BRIEF DESCRIPTION OF THE SEVERAL VIEWS OF THE DRAWINGS

To these and such other objects which may hereinafter appear, the present invention relates to a crystallization process using homogenization, as described in detail in the following specification and recited in the annexed claims, taken together with the accompanying drawings, wherein like numerals refer to like parts and in which:

FIG. 1 is a schematic drawing of the apparatus utilized to perform the process of the present invention;

FIG. 2 is a cross-sectional view of the chamber with the stator and rotor;

FIG. 3 is a cross-sectional view taken along line 3-3 of FIG. 2;

FIG. 4 is a cross-sectional view of a first preferred embodiment of the homogenization apparatus;

FIG. 5 is a cross-sectional view of a second preferred embodiment of the homogenization apparatus;

FIG. 6 is a cross-sectional view of a third preferred embodiment of the homogenization apparatus; and

FIG. 7 is a cross-sectional view of a fourth preferred embodiment of the homogenization apparatus.

### DETAILED DESCRIPTION OF THE INVENTION

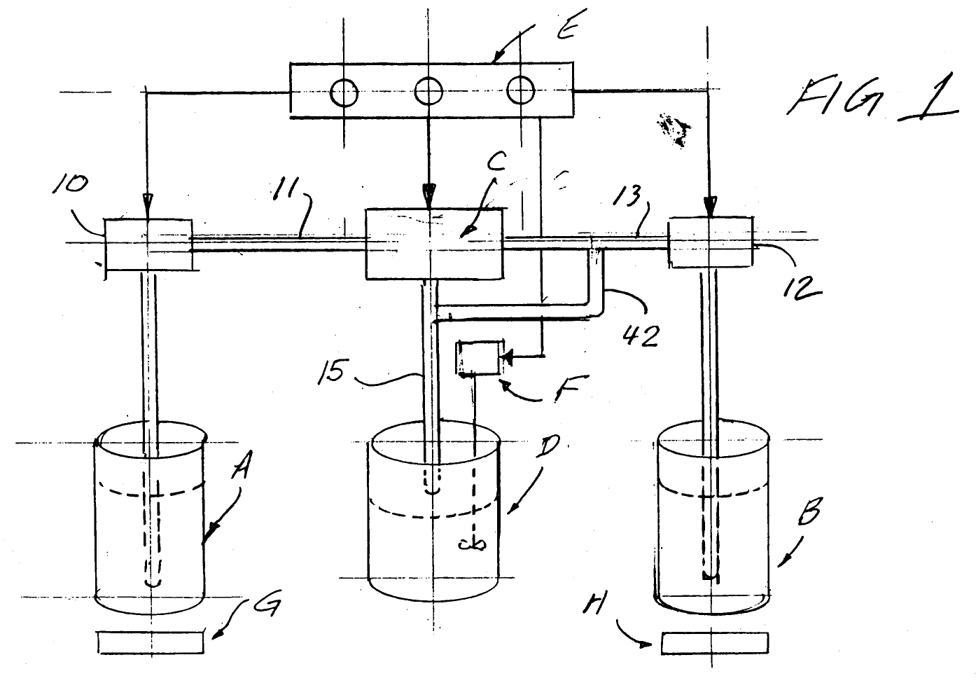

As illustrated in FIG. 1, the process of the present invention is used for crystallization of a chemical material, preferably an organic compound. It involves the use of two pumps and three vessels, in addition to the homogenization apparatus. The homogenization apparatus includes a chamber with a stator and a rotor. One vessel holds a first solution and functions as a source of that solution. The other vessel holds a second solution and functions as a source of that solution. The third vessel is used to collect the crystallized product, after it is removed from the homogenization apparatus. Pumps are used to control the feed rate of the first solution and of the second solution, respectively, to the homogenization chamber.

For simplicity, the apparatus is disclosed as it would be used to crystallize a material utilizing two constituents. However, it should be understood that additional constituents and sources of those additional constituents could be used, if the process so required.

The process is preferably performed continuously. The first solution is continuously mixed with the second solution by the rapid rotation of the rotor within the chamber. Shear, mixing and crystallization take place simultaneously in the chamber. Through the regulation of the flow rates of the solutions, as well as regulation of the agitation speed of the rotor, a high degree of control can be exercised over the particle size of the resulting crystals.

The first solution is situated in a first vessel, generally designated A. For non-reactive crystallization, the first solution may be a supersaturated solution of the material to be crystallized in a solvent. This solution may, for example, be 4-(5-chloro-2-hydroxyphenyl)-3-(2-hydroxyethyl)-6-(trifluoromethyl)-2(1H)-Quinolinone dissolved in ethanol. The second solution is situated in a second vessel, generally designated B. That solution is an anti-solvent, for example, water.

When used in reactive crystallization to form, for example, pharmaceutical salts, the first solution may be a solution containing a first reactive intermediate, for example, a reagent such as a base. The second solution may be a solution containing a second reactive intermediate, for example, a second reagent such as an acid.

For example, the first solution could be the free base 1-(3′-aminobenzisoxazol 5′yl)-trifluoronmethyl-5-[[4-[2′-dimethylaminomethyl)imidazol-1′-yl]-2-fluorophenyl]aminocarbgonyl]pyrazole dissolved in ethanol at 70 deg. C. The acid HCl, dissolved in isopropyl alcohol at 65 deg. C, could be the second solution. The solutions are introduced into the homogenization chamber and combined by rapid rotation of the rotor. The salt 1-(3′-aminobenzisoxazol-5′-yl)-3 trifluoromethyl-5-[[4-[(2′-dimethylaminomethyly)imidazol-1′yl]-2-fluorophenyl]aminocarbonyl]pyrazole.HCl is formed.

The solvents used to form the first and second solutions may be the same or different solvents. The solubility of the solvents differ based upon the polarity of the compounds. Additives such as surfactant or excipients may be included in the solutions. The parameters of the product may be changed depending upon the type of solvent.

As seen in the drawings, a first solution from vessel A is fed to the homogenization apparatus, generally designed C, by a first pump 10 through a supply conduit 11. The second solution from vessel B is fed to apparatus C by a second pump 12, through a supply conduit 13.

The material is crystallized in the chamber of apparatus C. The resulting crystal slurry is then discharged through conduit 15 into a collection vessel, generally designated D.

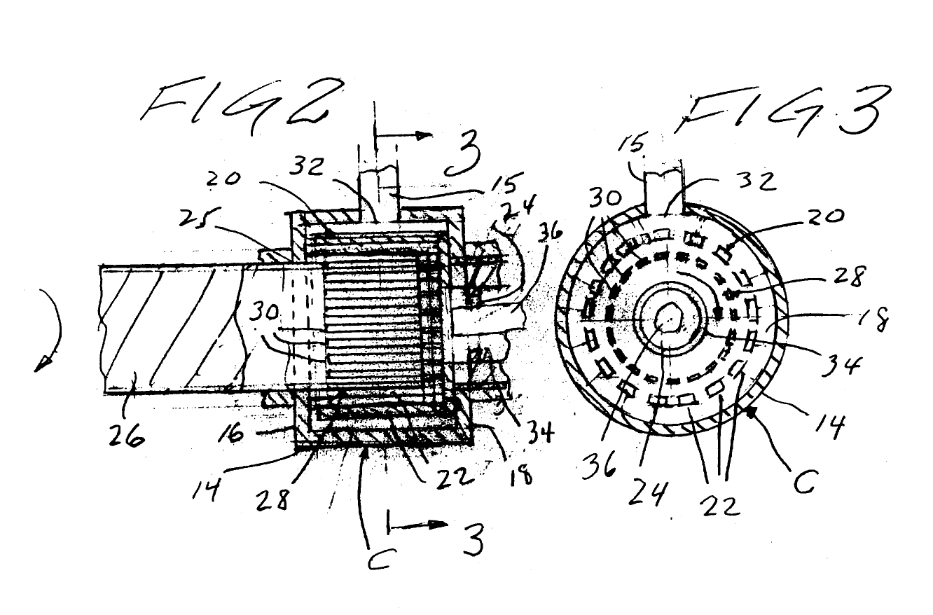

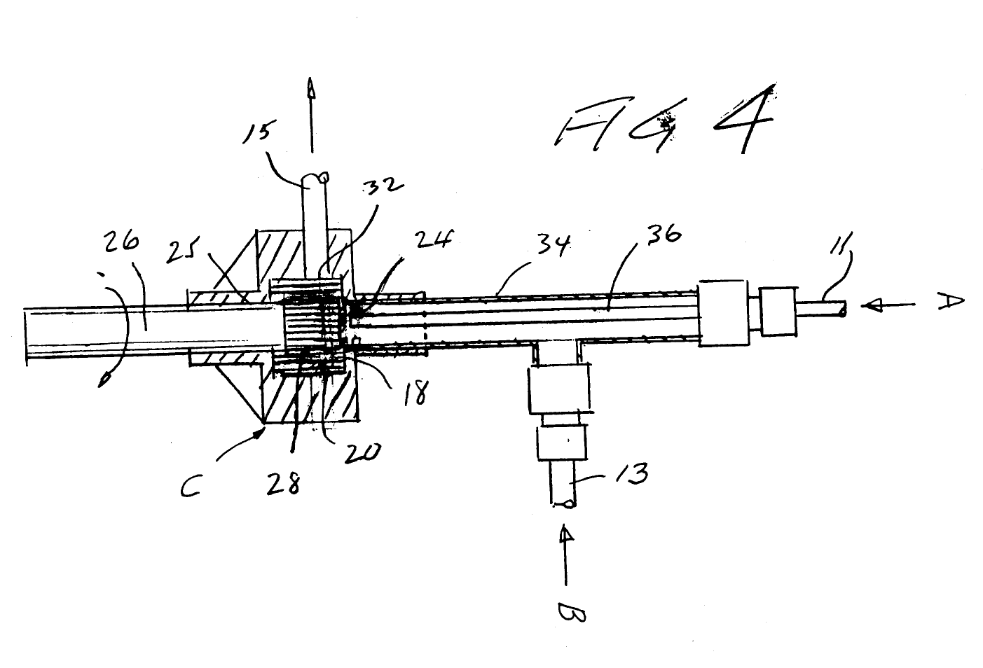

A control unit, generally designated E, is connected to pumps 10, 12 and to the motor (not shown) which drives the rotor 28 (FIGS. 2 and 3) in apparatus C. Control Unit E controls the speed of pumps 10, 12 and thus the flow rates of the solutions into apparatus C. It also controls the rotation speed of the rotor within apparatus C.

A mixer, generally designated F, is provided to mix the product in vessel D. Mixer F is also controlled by unit E.

Further, temperature control units, generally designated G and H, are provided. Units G and H control the temperature of the first solution and of the second solution, respectively, and may take the form of heaters, cooling baths or any other conventional temperature adjusting equipment.

FIGS. 2 and 3 illustrate the crystallization chamber of apparatus C in greater detail. The chamber is defined by a cylindrical wall 14, and side walls 16 and 18. Within wall 14 is situated a stator, generally designated 20, formed by a plurality of spaced stationary blades 22 which extend from and are fixedly mounted on the interior surface of side wall 18.

Side wall 18 has a centrally located chamber inlet port 24. The solutions are received into the chamber through port 24 from an inlet conduit 34, which in turn is connected to supply conduits 11 and 13.

Side wall 16 also has a central opening 25. The drive shaft 26 for rotor 28 extends through opening 25. Rotor 28 is formed of a plurality of spaced blades 30 which define a recess aligned with port 24.

Wall 14 has a chamber outlet port 32 located outside the stator blades 22. After processing, the crystallized product and the solvent mixture are removed from the chamber through port 32, which leads to conduit 15.

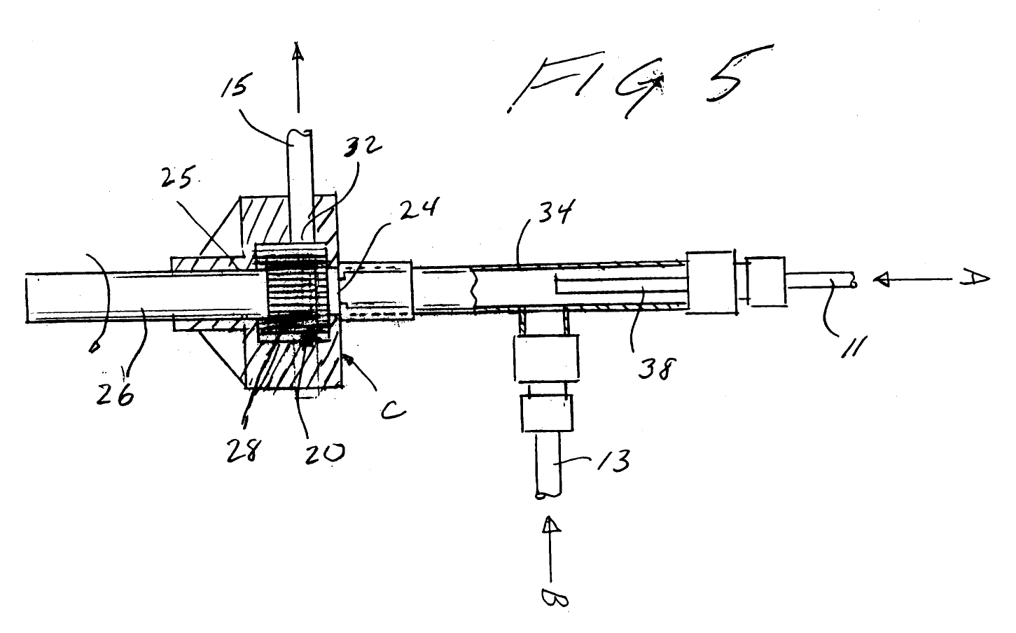

FIGS. 4, 5, 6 and 7 illustrate four different preferred embodiments of a homogenization apparatus which can be used to perform the process of the present invention. In each apparatus, a chamber defined by walls 14, 16 and 18 with a stator 20 formed of spaced stationary blades 22, a rotor 28 formed of spaced rotor blades 30, and inlet and outlet ports 24 and 32, are present. The main difference between the first three preferred embodiments is the structure of the input conduit. The fourth preferred embodiment involves a re-circulation system.

In the embodiment of FIG. 4, inlet conduit 34 includes an internal tube 36 connected to receive the first solution from vessel A, through supply conduit 11. Tube 36 extends into inlet port 24 of the chamber. The second solution is received from vessel B, through supply conduit 13, into the portion of inlet conduit 34 that surrounds tube 36. Accordingly, the solutions are introduced separately into the chamber. Crystallization, mixing and shear occur almost simultaneously within the chamber.

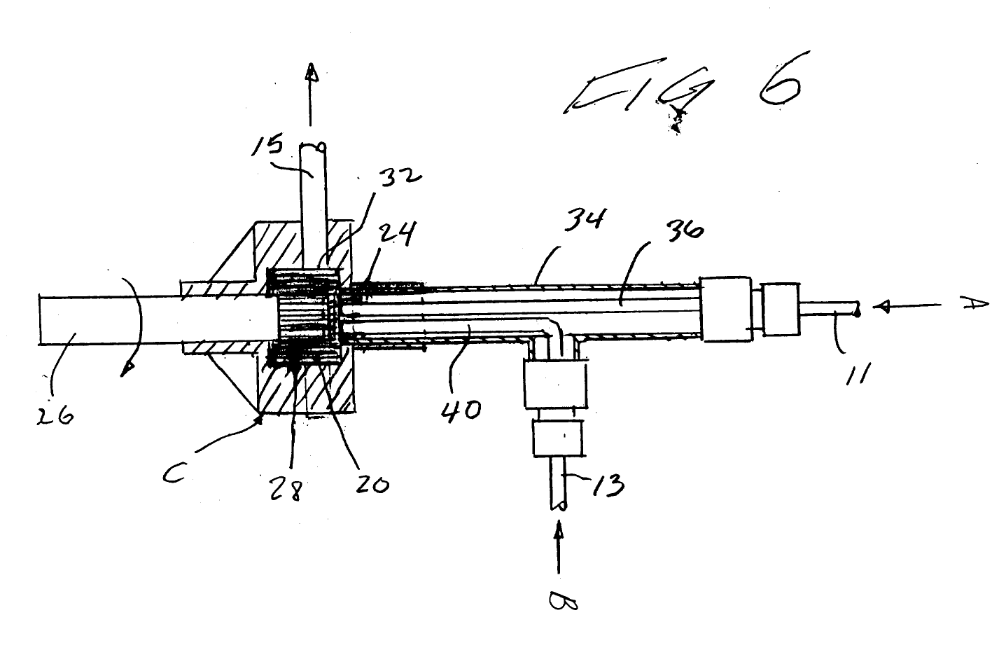

In the preferred embodiment of FIG. 5, an internal tube 38 is provided. Tube 38 is connected to vessel A by supply conduit 11 to receive the first solution. However, tube 38 does not extend into inlet port 24 like tube 36 of FIG. 4, but instead terminates some distance from the inlet port. Accordingly, in this embodiment, mixing of the solutions occurs within inlet conduit 34, prior to introduction of the solutions into the chamber. The length of tube 38 can be altered to change the point where mixing takes place.

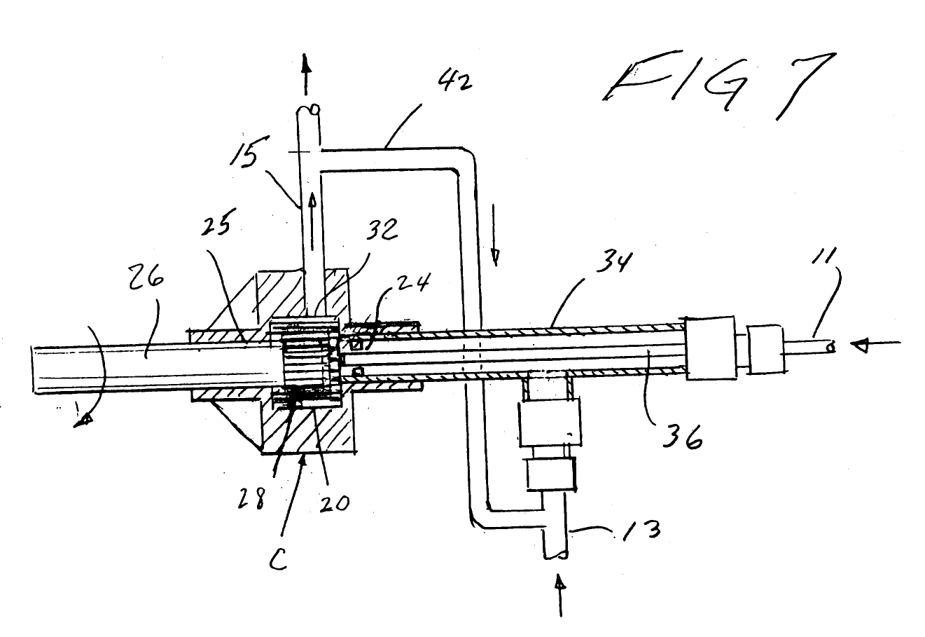

In the embodiment of FIG. 6, two separate inlet tubes 36 and 40 are present within tube 34. Tubes 36 and 40 are connected to conduits 11 and 13, respectively. The tubes have parallel end sections. The end sections of both tubes extend into port 24 such that the solutions are introduced separately into the chamber, as in the embodiment of FIG. 4.

Although the apparatus has been described for use in combining two solutions, in some instances, more than two solutions may be involved. In those situations, additional supply vessels, supply conduits and inlet conduits can be incorporated into the apparatus.

A wide range of rotor speeds can be used depending on the system of interest. The crystal size distribution of the product may vary with the rotor speed. Further, mixing of the product after it is removed from the chamber, by mixer F (shown in FIG. 1), may effect crystal size distribution by yielding smaller crystals.

The flow ratio of the solutions also effects crystal size distribution. Exemplary flow rates of 34.8 ml/min for the first solution and from 34.3 to 140.8 ml/min for the second solution have been used. Other flow rates may be selected according to the system components and reacting conditions.

The homogenization apparatus C can be obtained by modifying a commercially available ULTRA-TURRAX UTL 25 Inline dispenser, available from IKA Works, Inc. of 2635 North Chase Parkway SE, Wilmington, N.C. 28405. The conventional dispenser is modified for use in the process of the present invention by utilizing a custom designed T-shaped two port input conduit connected to the chamber inlet port, as illustrated in FIGS. 4, 5 and 6.

For some applications, it may be desirable to alter the temperature of one or both of the solutions prior to introduction into the chamber. For example, heating the first solution by a heater G and chilling the second solution using a cooling bath H may enhance supersaturation during the crystallization process.

It has also been found that adding seed crystals to the mixture of solutions may alter the crystalline form of the product. This can be accomplished by filling the chamber with seed crystals prior to beginning the process or continuously adding fresh seed crystals to one of the solutions.

It has been observed that if the seed crystals are present in the chamber prior to running, this seed material is gradually discharged from the chamber with the product, and is mostly washed away during longer runs. To overcome this problem, a modified apparatus, illustrated in FIG. 7, was developed.

The preferred embodiment of FIG. 7 is essentially the same as that of FIG. 4, with the addition of a recycle conduit 42 connecting outlet conduit 15, at a point beyond outlet port 32, and second solution supply conduit 13, at a point before it connects to conduit 34. Recycle conduit 42 serves to continually re-circulate a portion of the contents of the chamber, thereby providing seed material to the chamber on a continuous basis.

It should now be appreciated that the present invention relates to a crystallization process using homogenization that produces a pure crystallized compound with molecules having small, uniform particle size, high surface area and short dissolution time, which require no post-production milling. The stator/rotor structure within the chamber permits crystallization, mixing and shear to occur almost simultaneously. Problems of alignment of high velocity fluid jet streams and solution ratio control are entirely eliminated.

Although only a limited number of preferred embodiments of the present invention have been disclosed for purposes of illustration, it is obvious that many modifications and variations could be made thereto. It is intended to cover all of these modifications and variations which fall within the scope of the present invention, as set forth in the following claims:

We claim:

1. A process for crystallization of a chemical material from a first solution and a second solution utilizing apparatus comprising a chamber having a stator and a rotatable rotor, the process comprising the steps of: introducing the first solution and the second solution into the chamber; applying a high shear mixing force to the solutions to form the crystallized product by rapidly rotating the rotor relative to the stator; and removing the crystallized product from the chamber.

2. The process of claim 1 wherein the first solution comprises the material to be crystallized dissolved in a solvent and the solution comprises an anti-solvent solution.

3. The process of claim 1 wherein the first solution comprises a solvent and a first reactive intermediate and the second solution comprises a solvent and a second reactive intermediate and wherein said step of applying a high shear mixing force comprises applying the mixing force under conditions of temperature and pressure that permit reaction of the first and second reactive intermediate to form a product of limited solubility in the solvent mixture.

4. The process of claim 1 wherein each of the solutions is introduced separately into the chamber.

5. The process of claim 1 further comprising the step of mixing the solutions prior to introducing the solutions into the chamber.

6. The process of claim 1 wherein the step of introducing the solutions comprises the step of regulating the flow of the first solution into the chamber.

7. The process of claim 1 wherein the step of introducing the solutions comprises the step of adjusting the temperature of the first solution prior to introducing it to the chamber.

8. The process of claim 1 wherein the step of introducing the solutions comprises the step of regulating the flow of the second solution into the chamber.

9. The process of claim 1 wherein the step of introducing the solutions comprises the step of adjusting the temperature of the second solution prior to introducing it to the chamber.

10. The process of claim 1 further comprising the step of introducing seed crystals into the chamber.

11. The process of claim 10 wherein the step of introducing seed crystals comprises the step of introducing seed crystals to the chamber prior to the introduction of the solutions.

12. The process of claim 10 wherein the step of introducing seed crystals comprises the step of adding seed crystals to one of the solutions prior to introduction of that solution into the chamber.

13. The process of claim 10 where the step of introducing seed crystals comprises the step of providing fresh seed crystals to the chamber on a continuous basis.

14. The process of claim 13 wherein the step of providing fresh seed crystals comprises the step of continuously re-circulating a portion of the contents of the chamber.

15. The process of claim 14 wherein the step of re-circulating comprises the step of connecting the chamber outlet and the chamber inlet.

16. The process of claim 1 further comprising the step of mixing the crystal product after it is removed from the chamber.

17. A process for crystallization of a chemical material from solution containing the material to be crystallized dissolved in a solvent and an anti-solvent solution utilizing apparatus comprising a chamber having a stator and a rotatable rotor, the process comprising the steps of: introducing the material-containing solution and the anti-solvent solution into the chamber; applying a high shear mixing force to the solutions in the chamber to form the crystallized product by rapidly rotating the rotor relative to the stator; and removing the crystallized product from the chamber.

18. The process of claim 17 wherein each of the solutions is introduced separately into the chamber.

19. The process of claim 17 further comprising the step of mixing the solutions prior to introducing the solutions into the chamber.

20. The process of claim 17 wherein the step of introducing the solutions comprises the step of regulating the flow of the material-containing solution into the chamber.

21. The process of claim 17 wherein the step of introducing the solutions comprises the step of adjusting the temperature of the material-containing solution prior to introducing it to the chamber.

22. The process of claim 17 wherein the step of introducing the solutions comprises the step of regulating the flow of the anti-solvent solution into the chamber.

23. The process of claim 17 wherein the step of introducing the solutions comprises the step of adjusting the temperature of the anti-solvent solution prior to introducing it to the chamber.

24. The process of claim 17 further comprising the step of introducing seed crystals into the chamber.

25. The process of claim 24 wherein the step of introducing seed crystals comprises the step of introducing seed crystals to the chamber prior to the introduction of the solutions.

26. The process of claim 24 wherein the step of introducing seed crystals comprises the step of adding seed crystals to one of the solutions prior to introduction into the chamber.

27. The process of claim 24 where the step of introducing seed crystals comprises the step of providing fresh seed crystals to the chamber on a continuous basis.

28. The process of claim 27 wherein the step of providing fresh seed crystals comprises the step of continuously re-circulating a portion of the contents of the chamber.

29. The process of claim 28 wherein the step of re-circulating comprises the step of connecting the chamber outlet and the chamber inlet.

30. The process of claim 17 further comprising the step of mixing the product after it is removed from the chamber.

31. A process for crystallization of a chemical material from first solution comprising a solvent and a first reactive intermediate and a second solution comprising a solvent and a second reactive intermediate, utilizing apparatus comprising a chamber having a stator and a rotatable rotor, the process comprising the steps of: introducing the first solution and the second solution into the chamber; applying a high shear mixing force to the solutions in the chamber under conditions of temperature and pressure that permit reaction of the first and second reactive intermediates to form a product of limited solubility in the solvent mixture by rapidly rotating the rotor relative to the stator; and removing the product from the chamber.

32. The process of claim 31 wherein each of the solutions is introduced separately into the chamber.

33. The process of claim 31 further comprising the step of mixing the solutions prior to introducing the solutions into the chamber.

34. The process of claim 31 wherein the step of introducing the solutions comprises the step of regulating the flow of the first solution into the chamber.

35. The process of claim 31 wherein the step of introducing the solutions comprises the step of adjusting the temperature of the first solution prior to introducing it to the chamber.

36. The process of claim 31 wherein the step of introducing the solutions comprises the step of regulating the flow of the second solution into the chamber.

37. The process of claim 31 wherein the step of introducing the solutions comprises the step of adjusting the temperature of the second solution prior to introducing it to the chamber.

38. The process of claim 31 further comprising the step of introducing seed crystals into the chamber.

39. The process of claim 38 wherein the step of introducing seed crystals comprises the step of introducing seed crystals to the chamber prior to the introduction of the solutions.

40. The process of claim 38 wherein the step of introducing seed crystals comprises the step of adding seed crystals to one of the solutions prior to introduction into the chamber.

41. The process of claim 38 where the step of introducing seed crystals comprises the step of providing fresh seed crystals to the chamber on a continuous basis.

42. The process of claim 41 wherein the step of proving fresh seed crystals comprises the step of continuously re-circulating a portion of the contents of the chamber.

43. The process of claim 42 wherein the step of re-circulating comprises the step of connecting the chamber outlet and the chamber inlet.

44. The process of claim 31 further comprising the step of mixing the product after it is removed from the chamber.

45. Apparatus for crystallization of a chemical material from a first solution and a second solution, the apparatus comprising a first source of the first solution; a second source of the second solution; a chamber comprising a stator and a rotor, inlet means, connected to said chamber and to each of said first and second sources, for receiving the first solution and the second solution; means for rotating said rotor relative to said stator to form a crystallized product; and outlet means for removing the crystallized product from said chamber.

46. The apparatus of claim 45 wherein the first solution comprises the material to be crystallized dissolved in a solvent and the second solution comprises an anti-solvent solution.

47. The apparatus of claim 45 wherein the first solution comprises a solvent and a first reactive intermediate and the second solution comprises a solvent and a second reactive intermediate and wherein the mixing force is applied under conditions of temperature and pressure which permit reaction of the first and second reactive intermediates to form a product of limited solubility in the solvent mixture.

48. The apparatus of claim 45 wherein said inlet means comprises first and second conduits connected to said first and second sources, respectively, each of said conduits terminating in said chamber such that first solution and the second solution are introduced separately into said chamber.

49. The apparatus of claim 48 wherein one of said conduits is located within the other of said conduits.

50. The apparatus of claim 48 wherein said conduits comprise parallel end sections adjacent said chamber.

51. The apparatus of claim 45 wherein said inlet means comprises a mixing conduit between said first and second sources, and said chamber.

52. The apparatus of claim 45 further comprising first means for pumping the first solution from said first source to said chamber, through said inlet means.

53. The apparatus of claim 45 further comprising second means for pumping the second solution from said second source to said chamber, through said inlet means.

54. The apparatus of claim 45 wherein said rotor defines a recess and where the first solution and the second solution are received within said rotor recess.

55. The apparatus of claim 45 wherein said outlet means is located outside said stator.

56. The apparatus of claim 45 further comprising means for adjusting the temperature of the first solution.

57. The apparatus of claim 45 further comprising means for adjusting the temperature of the second solution.

58. The apparatus of claim 45 further comprising means for re-circulating a portion of the contents of said chamber.

59. The apparatus of claim 48 further comprising means for re-circulating a portion of the contents of said chamber.

60. The apparatus of claim 45 further comprising a re-circulation conduit connecting said outlet means and said inlet means.

61. The apparatus of claim 45 further comprising means for mixing the product after it is removed from said chamber.

62. The apparatus of claim 59 further comprising a re-circulation conduit connecting said outlet means and said inlet means.

63. The apparatus of claim 48 further comprising means for mixing the product after it is removed from said chamber.

64. Apparatus for crystallization of a chemical material from a solution containing the material to be crystallized dissolved in a solvent and a solution including an anti-solvent, the apparatus comprising: a first source of the material-containing solution; a second source of the anti-solvent solution; a chamber comprising a stator and a rotor; inlet means, connected to said chamber and to each of said first and second sources, for receiving the material-containing solution and the anti-solvent solution; means for rotating said rotor relative to said stator to form a crystallized product; and outlet means for removing the crystallized product from said chamber.

65. The apparatus of claim 64 wherein said inlet means comprises first and second conduits connected to said first and second sources, respectively, each of said conduits terminating in said chamber such that material-containing solution and the anti-solvent solution are introduced separately into said chamber.

66. The apparatus of claim 65 wherein one of said conduits is located within the other of said conduits.

67. The apparatus of claim 65 wherein said conduits comprise parallel end sections adjacent said chamber.

68. The apparatus of claim 64 wherein said inlet means comprises a mixing conduit between said first and second sources, and said chamber.

69. The apparatus of claim 64 comprising first means for pumping the material-containing solution from said first source to said chamber, through said inlet means.

70. The apparatus of claim 64 further comprising second means for pumping the anti-solvent solution from said second source to said chamber, through said inlet means.

71. The apparatus of claim 64 wherein said rotor defines a recess and where the material-containing solution and the anti-solvent solution are received within said rotor recess.

72. The apparatus of claim 64 wherein said outlet means is located outside said stator.

73. The apparatus of claim 64 further comprising means for adjusting the temperature of the material-containing solution.

74. The apparatus of claim 64 further comprising means for adjusting the temperature of the anti-solvent solution.

75. The apparatus of claim 64 further comprising means for re-circulating a portion of the contents of said chamber.

76. The apparatus of claim 65 further comprising means for re-circulating a portion of the contents of said chamber.

77. The apparatus of claim 64 further comprising a re-circulation conduit connecting said outlet means and said inlet means.

78. The apparatus of claim 64 further comprising means for mixing the product after it is removed from said chamber.

79. The apparatus of claim 65 further comprising a re-circulation conduit connecting said outlet means and said inlet means.

80. The apparatus of claim 65 further comprising means for mixing the product after it is removed from said chamber.

81. Apparatus for crystallization of a chemical material from a first solution comprising a solvent and a first reactive intermediate and a second solution comprising a solvent and a second reactive intermediate, said apparatus comprising a first source of the first solution; a second source of the second solution; a chamber comprising a stator and a rotor; inlet means, connected to said chamber and to each of the said first and second sources, for receiving the first solution and the second solution; means for rotating said rotor to combine the first and second solutions in said chamber under conditions of temperature and pressure that permit the first and second reactive intermediates to produce a product of limited solubility in the solvent mixture; and outlet means for removing the product from said chamber.

82. The apparatus of claim 81 wherein said inlet means comprises first and second conduits connected to said first and second sources, respectively, each of said conduits terminating in said chamber such that the first solution and the second solution are introduced separately into said chamber.

83. The apparatus of claim 82 wherein one of said conduits is located within the other of said conduits.

84. The apparatus of claim 82 wherein said conduits comprise parallel end sections adjacent said chamber.

85. The apparatus of claim 81 wherein said inlet means comprises a mixing conduit between said first and second sources, and said chamber.

86. The apparatus of claim 81 further comprising first means for pumping the first solution from said first source to said chamber, through said inlet means.

87. The apparatus of claim 81 further comprising second means for pumping the second solution from said second source to said chamber, through said inlet means.

88. The apparatus of claim 81 wherein said rotor defines a recess and wherein the first solution and the second solution are received within said rotor recess.

89. The apparatus of claim 81 wherein said outlet means is located outside said stator.

90. The apparatus of claim 81 further comprising means for adjusting the temperature of the first solution.

91. The apparatus of claim 81 further comprising means for adjusting the temperature of the second solution.

92. The apparatus of claim 81 further comprising means for re-circulating a portion of the contents of said chamber.

93. The apparatus of claim 82 further comprising means for re-circulating a portion of the contents of said chamber.

94. The apparatus of claim 81 further comprising a re-circulation conduit connecting said outlet means and said inlet means.

95. The apparatus of claim 81 further comprising means for mixing the product after it is removed from said chamber.

96. The apparatus of claim 82 further comprising a re-circulation conduit connecting said outlet means and said inlet means.

97. The apparatus of claim 82 further comprising means for mixing the product after it is removed from said chamber.
